(19) United States
(12) Patent Application Publication
(10) Pub. No.: US 2014/0172983 A1
(43) Pub. Date: Jun. 19, 2014

(54) SYSTEM, METHOD, DEVICE AND COMPUTER READABLE MEDIUM FOR DISTRIBUTING CONTENT EASILY SEEN BY TERMINAL DEVICE HAVING SMALL DISPLAY PART

(71) Applicant: CASIO COMPUTER CO., LTD., Tokyo (JP)

(72) Inventor: Keiichi IMAMURA, Tokyo (JP)

(73) Assignee: CASIO COMPUTER CO., LTD., Tokyo (JP)

(21) Appl. No.: 14/104,268

(22) Filed: Dec. 12, 2013

(30) Foreign Application Priority Data
Dec. 13, 2012 (JP) 2012-272148

(51) Int. Cl. H04L 29/08

(52) U.S. Cl. CPC H04L 67/10
USPC 709/204

(57) ABSTRACT

A content distributing system includes first and second terminal devices and a content processing server device. In the content processing server device, a selecting unit selects content information for the first terminal device, a content processing unit generates simple content information optimized for the second terminal device based on the selected content information and a distributing unit transmits the generated simple content information with the content information to the first terminal device. In the first terminal device, a receiving unit receives the content information from the content processing server device, a determining unit determines whether the simple content information is in the received content information and a transfer unit transfers the determined simple content information to the second terminal device. In the second terminal device, a receiving unit receives the simple content information transferred from the first terminal device and an output unit outputs the received simple content information.

### CROSS-REFERENCE TO RELATED APPLICATION

This application claims priority based on Japanese Patent Application No. 2012-272148, filed on Dec. 13, 2012, the entire contents of which are incorporated by reference herein.

### BACKGROUND OF THE INVENTION

1. Field of the Invention

The present invention relates to a content distributing technique which allows a user to more assuredly and effectively recognize content distributed and transmitted to a smart phone or a wrist watch type display device.

2. Description of the Related Art

For the purpose of distributing content adapted to a state of a terminal which receives the content, a technique is proposed that distributed information is adopted, rejected or selected in accordance with a range of the distributed information which is previously defined in association with a communication connection state of the terminal (for instance, JP-A-2006-330933).

Further, a technique is also proposed that simple content are generated for a display device having a small display screen (for instance, JP-A-2006-108925).

The technique disclosed in the above-described JP-A-2006-330933 is supposed to be proposed by considering a situation that when content of a large capacity is distributed and transmitted at a relatively low communication speed, a long communication time is necessary to deteriorate a communication function for an original portable terminal.

Further, the technique disclosed in the above-described in JP-A-2006-108925 is proposed in order to display a readily seen index table.

In recent years, more multifunctional small portable terminals with higher performances which are called smart phones are widely spread in place of portable telephones and an LTE (Long Term Evolution) is already put to practical use at present as a communication environment and as a high speed communication network. Inconveniences arise from a different point of view from the techniques disclosed in the above-described JP-A-2006-330933 and JP-A-2006-108925.

### SUMMARY OF THE INVENTION

According to one aspect of the present invention, a content distributing system includes a first terminal device, a second terminal device and a content processing server device. The content processing server device includes a selecting unit, a content processing unit and a distributing unit. The selecting unit selects whether or not content information for the first terminal device needs to be outputted to the second terminal device. The content information for the first terminal device is provided from an external part. The content processing unit generates simple content information optimized for the second terminal device based on the content information for the first terminal device which is selected as the necessary content information by the selecting unit. The distributing unit distributes and transmits the simple content information generated by the content processing unit together with the original content information for the first terminal device to the first terminal device. The first terminal device includes a first receiving unit, a determining unit and a transfer unit. The first receiving unit receives the content information distributed and transmitted from the content processing server device. The determining unit determines whether or not the simple content information is added to the content information received by the first receiving unit. The transfer unit transfers the simple content information to the second terminal device when the determining unit determines that the simple content information is added to the content information. The second terminal device includes a second receiving unit and an output unit. The second receiving unit receives the simple content information transferred from the first terminal device. The output unit outputs the simple content information received by the second receiving unit.

According to another aspect of the present invention, a server device provides content to a portable information terminal device and a wearable terminal device which is connected to the portable information terminal device. The server device includes a selecting unit, a content processing unit and a distributing unit. The selecting unit selects whether or not content information for the portable information terminal device needs to be outputted to the wearable terminal device. The content information for the portable information terminal device is provided from an external part. The content processing unit generates simple content information optimized for the wearable terminal device based on the content information for the portable information terminal device which is selected as the necessary content information by the selecting unit. The distributing unit distributes and transmits the simple content information generated by the content processing unit together with the original content information for the portable information terminal device to the portable information terminal device.

According to another aspect of the present invention, a wearable terminal device is connected to a portable information terminal device. The wearable terminal device includes a receiving unit and an output unit. The receiving unit receives simple content information, which includes tag information for designating a report form, which is transferred from the portable information terminal device, which is generated based on content information for the portable information terminal device and which is optimized for the wearable terminal device. The output unit outputs the simple content information received by the receiving unit in the report form in accordance with the tag information included in the simple content information.

### BRIEF DESCRIPTION OF THE DRAWINGS

FIG. 1 is a diagram showing a structure of an entire part of a content distributing system according to one exemplary embodiment of the present invention.

FIG. 2 is a block diagram showing a functional structure of an electronic circuit in a wrist terminal according to the exemplary embodiment.

FIG. 3 is a diagram showing a series of flow concerning a distribution of content information which is carried out between a content processing server and a smart phone and a wrist terminal according to the exemplary embodiment.

FIG. 4 is a flowchart showing a detail of a display process of simple content information in the wrist terminal according to the present exemplary embodiment.

FIG. 5A, FIG. 5B and FIG. 5C are diagrams which illustrate display states of the simple content information in the wrist terminal 7 in accordance with report forms in the present exemplary embodiment.

FIG. 6A, FIG. 6B, FIG. 6C and FIG. 6D are diagrams which illustrate specific examples of various kinds of simple content information displayed in a display part in the present exemplary embodiment.

FIG. 7A and FIG. 7B are diagrams which illustrate specific examples of various kinds of simple content information generated in the smart phone and displayed in the display part of the present exemplary embodiment.

### DETAILED DESCRIPTION OF THE PREFERRED EMBODIMENTS

Now, one exemplary embodiment formed when the present invention is applied to a content distributing system will be described below by referring to the drawings.

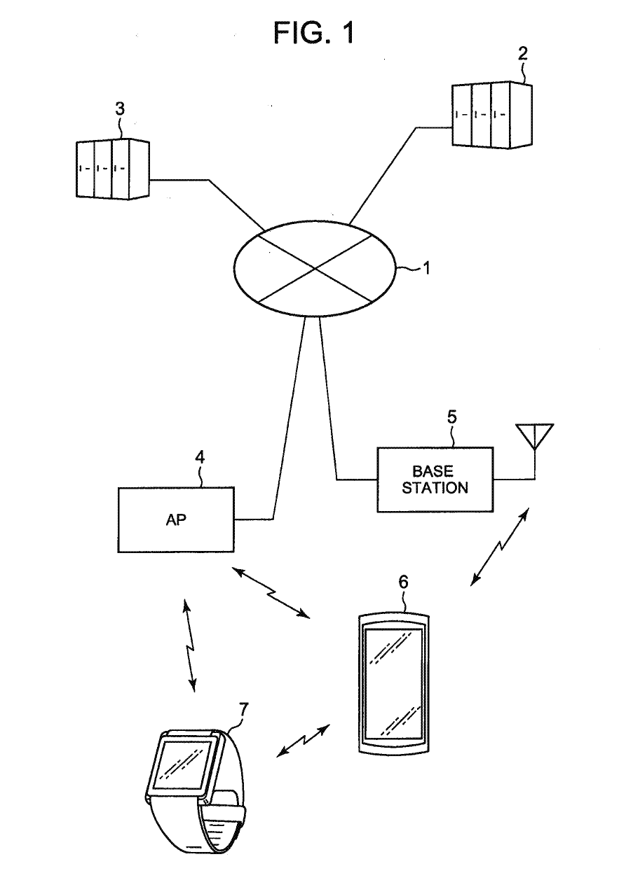

FIG. 1 is a diagram showing a structure of an entire part of a content distributing system according to the exemplary embodiment of the present invention. In FIG. 1, to a network 1 including Internet, a content server 2 is connected which provides various kinds of content and a content processing server 3 is connected which generates simple content for a below-described wrist terminal 7.

The content server 2 representatively indicate many server devices which provide various kinds of content information to be reproduced by a personal computer or a smart phone, for instance, a server device which provides a search engine, a server device which provides an SNS (Social Networking Service), a server device which provides moving images and a server device which provides web sites of enterprises respectively.

On the other hand, the above-described content processing server 3 is provided for a content distributing service of a member system which is managed by an enterprise that produces, for instance, below-described wrist terminals 7. The content processing server 3 generates and distributes and transmits simple content information as required to the various kinds of content information provided from the content server 2.

Further, to the network 1, an access point (AP) 4 or a base station 5 of a mobile telephone network is connected through a service provider which is not shown in the drawing. A smart phone 6 as a portable terminal device carried by an ordinary user can be connected to the network 1 via a wireless LAN according to, for instance, IEEE802.11a/b/g/n standard through the access point 4, and, on the other hand, connected to the network 1 likewise through the base station 5.

Further, the wrist terminal 7 as a wearable terminal device which a user having the smart phone 6 wears on his or her wrist can be also connected to the network 1 via the wireless LAN through the above-described access point 4. On the other hand, the wrist terminal 7 can transmit data or receive data by establishing a pairing setting between the smart phone 6 and the wrist terminal 7 by a Bluetooth (a registered trademark) technique as a short range radio-communication standard.

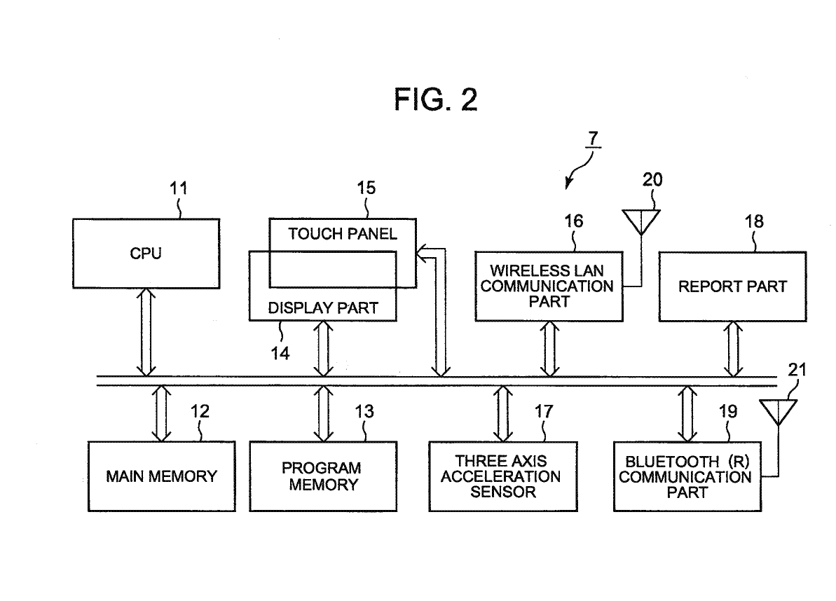

Now, referring to FIG. 2, a functional structure of an electronic circuit in the wrist terminal 7 will be described below. In FIG. 2, reference numeral 11 designates a CPU which generally controls an operation of an entire part of the wrist terminal 7. To the CPU 11, a main memory 12, a program memory 13, a display part 14, a touch panel 15, a wireless LAN communication part 16, a three axis acceleration sensor 17, a report part 18 and a Bluetooth (the registered trademark) communication part 19 are connected through a bus B.

The main memory 12 is formed with, for instance, an SRAM and functions as a work memory of the above-described CPU 11. The program memory 13 is formed with, for instance, a flash memory to store operation programs or various kinds of standardized data executed by the CPU 11 and simple content data received from the smart phone 6.

The CPU 11 suitably reads the operation programs including an OS and application programs from the program memory 13 to expand the operation programs on the main memory 12 and sequentially executes the expanded programs in the program memory 13 to control an operation of the wrist terminal 7.

Further, the CPU 11 incorporates therein an RTC (Real Time Clock) to keep a timer operation of present time so that the wrist terminal 7 may be also used as a wrist watch.

The display part 14 is formed with a color liquid crystal panel having, for instance, a length of 240 dots×a width of 240 dots and a back light thereof and a driving circuit to display date and time information as a clock function or images of various kinds of received content data.

On the display part 14, the touch panel 15 using a transparent electrode film is provided integrally therewith. The touch panel 15 generates two-dimensional coordinate information according to a touch operation of a hand or finger of the user who wears the wrist terminal 7 to transmit an operation signal to the CPU 11.

The wireless LAN communication part 16 transmits and receives the data between the nearest access point 4 and the wireless LAN communication part 16 through a wireless LAN antenna 20 by a wireless LAN technique according to the above-described IEEE802.11a/b/g/n standard.

The three axis acceleration sensor 17 detects accelerations, which are exerted on the wrist terminal 7 at that time, respectively along the axial directions of three axes which mutually intersect at right angles to detect an attitude angle of the wrist terminal 7 in a three-dimensional space including a gravitational acceleration direction (a vertical direction) and a change of an attitude due to an external force.

The report part 18 has a buzzer part which generates, for instance, a beep sound and a vibrator part which generates a vibration to carry out a report operation when the simple content information is transferred to the wrist terminal 7 as described below or when it is a previously set alarm time.

The Bluetooth communication part 19 transmits data to or receives data from a device which previously establishes the pairing setting through a Bluetooth antenna 21, for instance, the above-described smart phone 6.

Since the above-described content processing server 3 and structures of hardware circuits of the smart phone 6 are supposed to be extremely ordinarily known technique, illustrations and explanations of them will be omitted.

In the above-described smart phone 6, below-described application programs cooperating with a communication are previously installed and connection settings to the content processing server 3 and the wrist terminal 7 are respectively completed in accordance with the programs. Thus, the simple content information added to content information for various kinds of applications provided from the content processing server 3 can be transferred to the wrist terminal 7.

Now, an operation of the above-described exemplary embodiment will be described below.

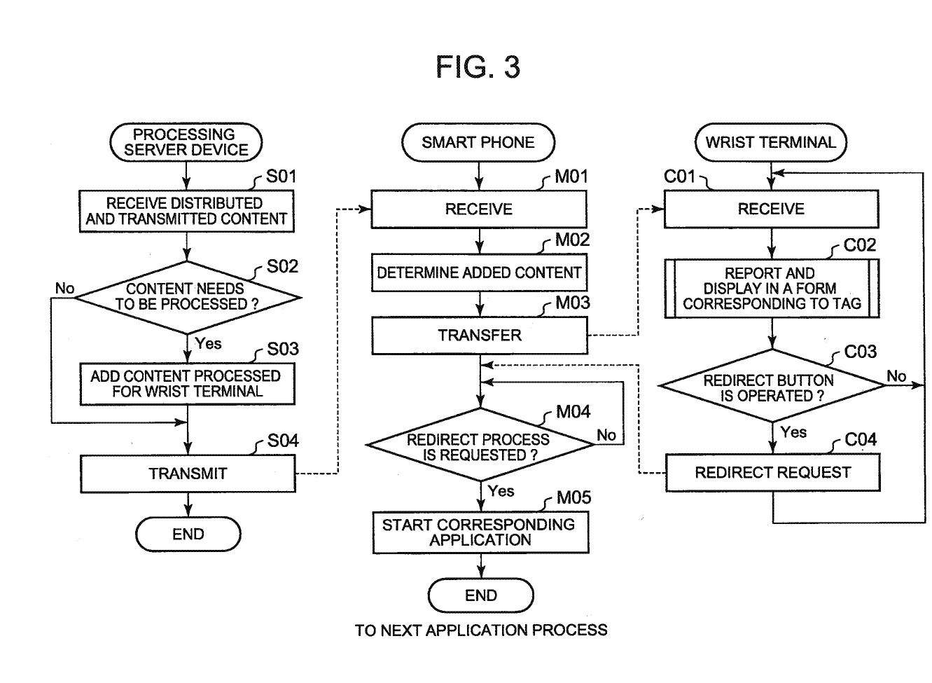

FIG. 3 is a diagram showing a series of flow concerning a distribution of the content information which is carried out between the content processing server 3 and the smart phone and the wrist terminal 7.

In the content processing server 3, user information of the user who uses the smart phone 6 and a display setting in the wrist terminal 7, for instance, a display image size of the touch panel 15 or the like are supposed to be previously registered.

Namely, in the user information, information showing whether or not the simple content information is generated for each of types of the content information and transmitted or personal information such as a routine behavior pattern of the user in a day is supposed to be previously registered and included by operations according to the application programs cooperating with the communication in the smart phone 6.

When the content processing server 3 receives a provision of the content information from the content server 2 (step S01), the content server 3 selects whether or not the received content information requires a display of the simple content information on the wrist terminal 7 or whether or not the content information needs to be processed in accordance with content registered in the user information (step S02).

Namely, in the content processing server 3, as described above, is previously registered whether or not the simple content information is generated for each of the application programs required as the user information. For instance, when a service for providing weather forecasting information, a service for providing an SNS, a service for providing transportation information and a service for providing a guide image of a car navigation are previously registered as the services the simple content information of which are supposed to be generated, it is possible to easily select whether or not the simple content information needs to be processed.

In the above-described step S02, when it is selected that the content information needs to be processed, the content processing server 3 reads information of the display setting for displaying on the wrist terminal 7 to generate the simple content information optimized for the wrist terminal 7 (step S03).

As an optimizing process for obtaining the simple content information, several optimizing processes may be considered. For instance, a method is considered in which the original content information shaped and displayed by an HTML (HyperText Markup Language) is rasterized to reduce the image size. When originally provided text data or various kinds of information tags are managed so as to be included by an XML (Extensible Markup Language) separately from the generated raster data, the simple content information can be generated which has no deficiency in information as content, though the image size is reduced.

At this time, the content processing server 3 attaches tag information for a report corresponding to the kind of the content information and time information showing a term of validity to the generated simple content information.

Then, when the content processing server 3 generates the simple content information by the process in the above-described step S03, the content processing server 3 adds the simple content information to the original content information. Further, when the content processing server 3 does not generate the simple content information, the content processing server 3 transmits only the original content information to the smart phone 6 (step S04). In such a way, the content processing server 3 finishes a series of processes and returns to the first process to move to a next distribution of content.

Subsequently, as a method of the optimizing process for obtaining the simple content information, an example that uses a template will be described below.

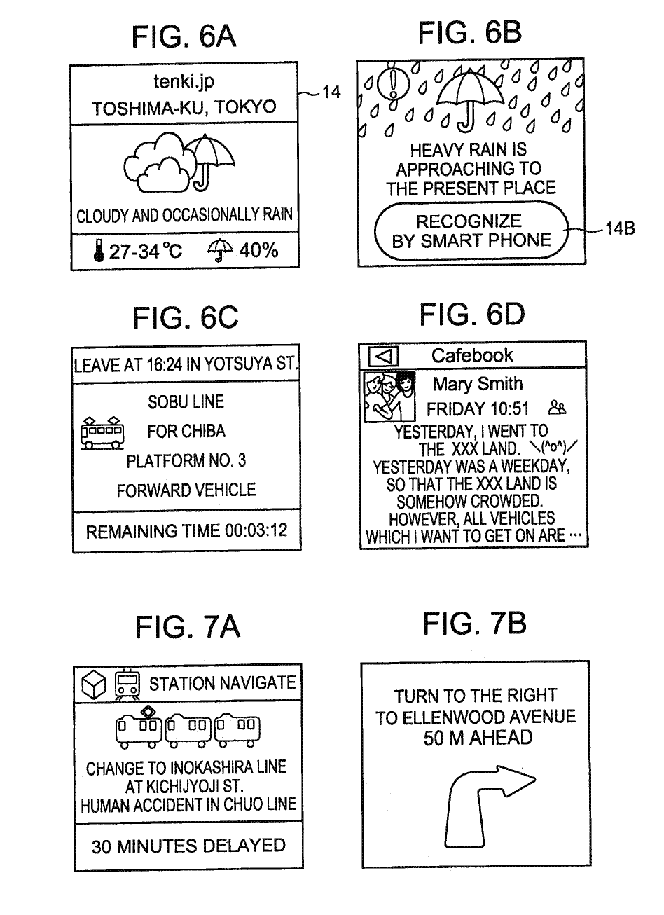

When the content processing server 3 obtains data from the content server 2, since a form and an item of the data are previously understood, a rule is previously determined for the item of the obtained data that indicates “in which part of the template the item of the obtained data is to be put”. Thus, only a heading of template content may be applied to a detailed part, so that only a required and minimum part of the content can be displayed on the wrist terminal 7 as illustrated in FIGS. 6A to 6D or FIGS. 7A to 7B.

Namely, the template designates a format showing how and which part of the content is displayed on the display part 14 of the wrist terminal 7.

However, since the rule indicating that in which part of the template the item of the obtained data is to be put is different respectively for forms and items of data of content of a content distributing or transmitting company, when distributed content are increased, a server program is executed so as to form optimum display screens respectively adapted to the rules.

When the smart phone 6 receives the content information distributed and transmitted from the content processing server 3 through the network 1 (step M01), the smart phone 6 determines whether or not the simple content information for the wrist terminal 7 is added to the received content information (step M02).

Here, when the simple content information is added to the received content information, the smart phone 6 recognizes that the wrist terminal 7 is connected to the smart phone by the Bluetooth standard, and then, transfers the added simple content information to the wrist terminal 7 (step M03).

When the wrist terminal 7 connected to the smart phone 6 receives the simple content information transferred from the smart phone 6 (step C01), the wrist terminal 7 carries out a display process together with a report according to the attached tag information (step C02). A detail of the display process in the wrist terminal 7 will be described below.

With the display of the simple content information, in the wrist terminal 7, an operating button called a redirect button is provided which displays the original content information for the smart phone 6 in the displayed content to determine whether or not the button is touched and operated by the user (step C03).

When the operating button called the redirect button is not provided or when the redirect button is provided, however, it is not touched nor operated by the user, the wrist terminal 7 temporarily finishes a series of processes and returns to the processes from the step C01 to prepare for a reception of next simple content information.

On the other hand, in the step C03, when the operating button called the redirect button is present and the wrist terminal 7 determines that the button is touched and operated by the user, the wrist terminal 7 transmits a signal for requesting the smart phone 6 to carry out a redirect process (step C04), then, temporarily finishes a series of processes and returns to the processes from the step C01 to prepare for a reception of a next simple content information.

After the smart phone 6 transfers the simple content information to the wrist terminal 7 in the above-described step M03, the smart phone 6 waits for the request for the redirect which is transmitted from the wrist terminal 7 (step M04).

Then, when the request for the redirect is transmitted from the wrist terminal 7, the smart phone 6 determines that the request for the redirect is transmitted from the wrist terminal 7 in the above-described step M04 to automatically start the corresponding application program (step M05). Thus, the smart phone 6 finishes a series of processes and moves to a process by the activated application program.

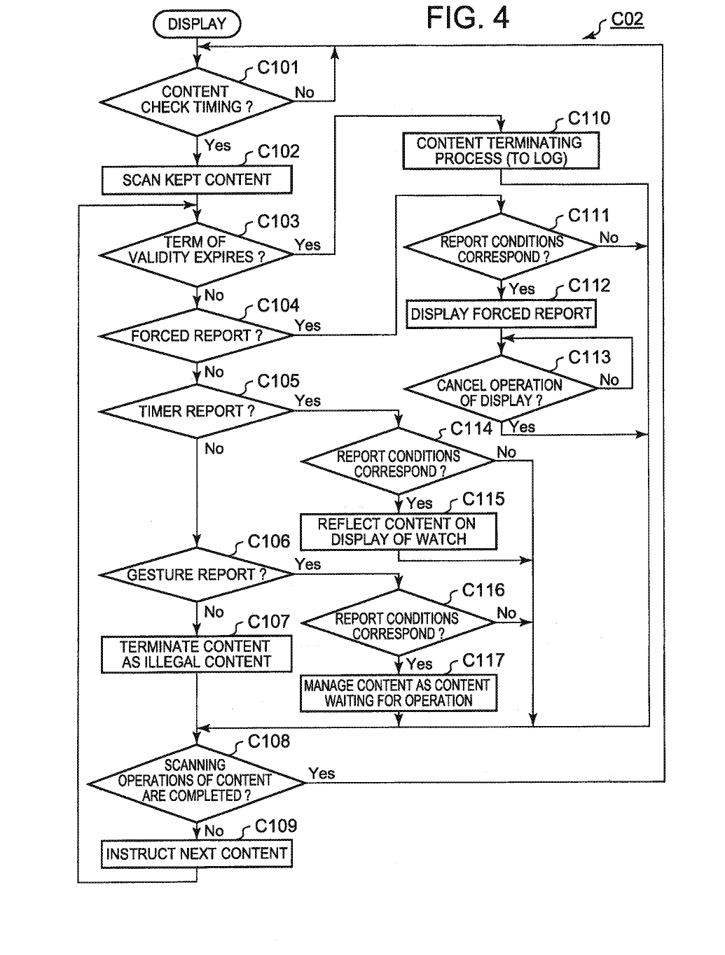

Now, by referring to FIG. 4, the display process of the simple content information in the above-described step C02 in the wrist terminal 7 will be described below.

Processes shown in FIG. 4 indicate content of processes carried out by using the main memory 12 in accordance with a data transmitting and receiving program which the CPU 11 reads from the program memory 13 in the wrist terminal 7, and similarly in accordance with the application programs for displaying the content application respectively read from the program memory 13.

Initially, the CPU 11 waits for an elapse of a previously set prescribed time, for instance, 10 seconds so that it is a check timing of the content information (step C101). When the CPU 11 determines that it is the check timing in the step C101, the CPU scans whether or not there is the received simple content information which is kept in the program memory 13 and selects one of the simple content information (step C102). The CPU 11 compares the time information showing the term of validity which is attached to the selected simple content information with a present time timed by an RTC in the CPU 11 to determine whether or not the term of validity of the simple content information expires (step C103).

Here, when the CPU 11 determines that the time information in the simple content information is older than the present time timed by the RTC and the term of validity of the simple content information expires, the CPU 11 generates and stores log information of a reception of the simple content information and erases the simple content information itself as the information to be terminated (step C110).

After that, the CPU 11 scans again whether or not there is other simple content information in the program memory 13 to determine whether or not processes of all the simple content information are completed (step C108).

Here, when the CPU 11 determines that there is still other simple content information, the CPU 11 instructs next simple content information (step C109), and then, returns again to processes from the above-described step C103.

Further, in the step C103, when the CPU 11 determines that the time information showing the term of validity attached to the selected simple content information is later than the present time and the term of validity of the simple content information does not expire, then, the CPU 11 determines whether or not the simple content information is simple content information in which a setting of a “forced report” is established from the tag information showing a form of a report attached to the simple content information (step 104).

Namely, in the present exemplary embodiment, the form of the report is supposed to have any one of the “forced report”, a “gesture report” and a “timer report”.

Here, in the “forced report”, when the simple content information is received, the CPU 11 forcibly informs the user of the wrist terminal 7 of the reception of the content.

Further, in the “gesture report”, when a specific gesture by the user of the wrist terminal 7, for instance, such an operation as to turn the wrist terminal 7 along the axial direction of a forearm of the user who wears the wrist terminal 7, more specifically, a gesture operation of the user of the wrist terminal 7 to see the display part 14 of the wrist terminal 7 is carried out, the CPU 11 displays the content.

In the “timer report”, the CPU 11 displays the present time in the display part 14 together with the simple content information in accordance with a report time condition set in the simple content information and does give a report itself to the user.

In the above-described step C104, when the CPU 11 determines that the tag information of the simple content information does not show the “forced report”, then, the CPU 11 determines whether or not the tag information shows the “timer report” (step C105).

Here, when the CPU 11 determines that the tag information does not show the “timer report”, the CPU 11 further determines whether or not the tag information shows the “gesture report” (step C106).

Here, when the CPU 11 determines that the tag information does not show “the gesture report”, the CPU 11 considers the simple content information to be illegal content information and erases the simple content information by considering the simple content information itself to be terminated (step C107), and then, advances to the process of the above-described step C108.

In the above-described step C106, when the CPU 11 determines that the tag information shows the “gesture report”, then, the CPU 11 determines whether or not report conditions correspond, namely, whether or not information of a specific gesture operation defined in the simple content information corresponds to a detecting signal according to an operation of the wrist terminal 7 which is detected from the three axis acceleration sensor 17 by calculating an approximation and comparing the calculated approximation with a threshold value of a previously set approximation (step C116).

Here, only when the CPU 11 determines that the detecting signal from the three axis accelerations sensor 17 is close to the information of the specific gesture operation and the specific gesture operation is carried out, the CPU 11 merely displays the simple content information on the display part 14 as content which is not especially reported and is managed as simple content information waiting for an operation (step C117) and advances to the process of the above-described step C108.

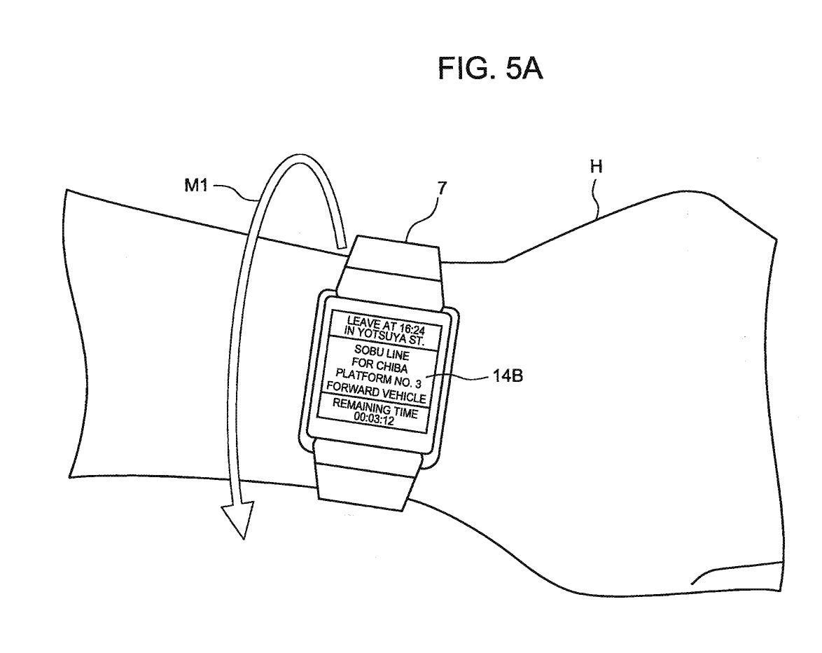

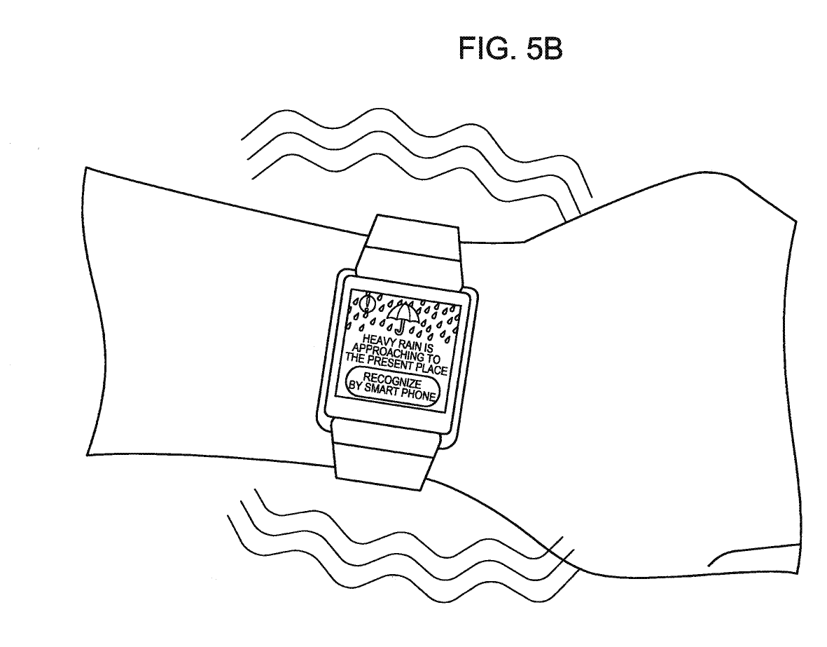

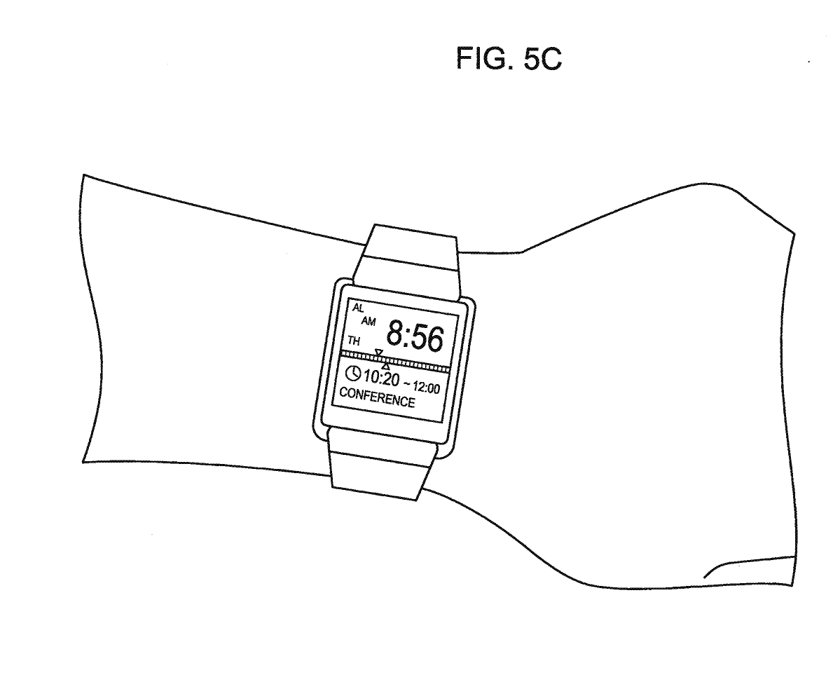

FIG. 5A is a diagram which illustrates a display state of the simple content information in the “gesture report”. At this time, when such an operation, is carried out, as to rotate the forearm of the user who wears the wrist terminal 7 on an axial direction thereof as a center as shown by an arrow mark M1 in the drawing, the CPU 11 considers that the report conditions correspond to each other and shows on the display part 14 the simple content information of the transportation information. Specifically, FIG. 5A shows transferring information of an electric train, for example. At this time, other notice unit, for instance, the report part 18 does not output the beep sound, nor generate the vibration of the vibrator by considering them as the content in a stand-by state as described above.

In the above-described step C116, when the CPU 11 determines that the detecting signal from the three axis accelerations sensor 17 is far from the information of the specific gesture operation and the specific gesture operation is not carried out, the CPU 11 does not display the simple content information in the above-described step C117 and directly advances to the process of the step C108.

Further, in the above-described step C104, when the CPU 11 determines that the tag information of the simple content information shows the “forced report”, then, the CPU 11 determines whether or not the report conditions defined in the simple content information correspond, for instance, the CPU 11 determines whether or not the simple content information is “weather information” and whether or not content of the information includes “rain” or “snow” (step C111).

Here, only when the CPU 11 determines that the report conditions correspond to each other, the CPU 11 considers the simple content information to be the forced report and displays the simple content information on the display part 14 as the content accompanied by the report (C112).

FIG. 5B is a diagram which illustrates a display state of the simple content information in the “forced report”. At this time, in the wrist terminal 7, the vibration is forcibly generated in the vibrator part by the report part 18 to inform the user who wears the wrist terminal 7 of the reception of the simple content information. This illustrates an example that the simple content information of the weather information is displayed on the display part 14 and includes the “rain” in the weather information as the report condition. Since the report conditions correspond to each other, the example is shown that the display accompanied by the forced report is carried out as described above.

In the above-described step C111, when the CPU 11 determines that the report conditions do not correspond to each other, for instance, not the “rain” nor the “snow” is included in the weather information, the CPU 11 does not display the simple content information in the step C112 and directly advances to the process of the above-described step C108.

As for the forced report in the step C111, since it is supposed to be essentially necessary for the user to carry out an operation for canceling the report after the user recognizes the forced report, the CPU 11 waits for a previously set cancel operation to be carried out, for instance, an operation that the touch panel 15 is tapped on the display part 14.

Then, when the previously set cancel operation is carried out, the CPU 11 determines it in the step C113 and advances to the process of the above-described step C108.

Further, in the above-described step C105, when the CPU 11 determines that the tag information of the simple content information shows the “timer report”, then, the CPU 11 determines whether or not the report condition defined in the simple content information corresponds thereto, for instance, whether or not the simple content information is “schedule information” of the user of the wrist terminal 7 and whether or not the inputted schedule draws near to a prescribed time (ex. two hours) (step C114).

Here, only when the CPU 11 determines that the report conditions correspond to each other, the CPU 11 considers the simple content information to show the timer report and displays the simple content information on the display part 14 by reflecting it on a part of the display of a watch on the display part 14 (step C115).

FIG. 5C is a diagram which illustrates a display state of the simple content information in the “timer report”. At this time, in the wrist terminal 7, an example is illustrated in which present date and time and a day of the week are displayed on an upper part of the display part 14, and a time base of the present time and a subsequent schedule “business strategic conference” and a range of a predetermined time of the conference are displayed from a center to a lower part. As report conditions, the present time is located within a range of, for instance, two hours relative to a predetermined start time of the conference, so that the report conditions correspond to each other. Thus, the example is shown that such a time report as described above is displayed.

In the above-described step C114, when the CPU 11 determines that the report conditions do not correspond to each other, for instance, when the present time is earlier by two hours or more than the start time of the inputted schedule, the CPU 11 does not display the simple content information in the above-described step C117 and directly advances to the process of the above-described step C108.

FIGS. 6A to 6D show diagrams which illustrate specific examples of various kinds of simple content information displayed in the display part 14.

FIG. 6A shows the example of the simple content information of the weather information. Here, weather and an expected temperature range and a probability of rainfall of “Toshima-ku in Tokyo”.

FIG. 6B similarly shows the example of the simple content information of “weather forecasting”. Here, the above-described “redirect button” 14B is displayed together so as to meet a warning report or an alarm. Thus, the smart phone 6 may shift to the automatic start of the application for the weather forecasting, as displayed by characters “recognize by the smart phone” in the “redirect button” 14B.

In this case, as described in FIG. 3, by operating the above-described redirect button 14B of the display part 14, the redirect request is transmitted to the smart phone 6 from the wrist terminal 7. The smart phone 6 automatically starts the application for the weather information”. Thus, the user can inspect detailed content information with a good maneuverability as required without a complicated operation.

FIG. 6C shows the example which displays the simple content information of the transportation information provided when the user prescribes the routine behavior pattern, specifically, the simple content information of a transferring guide of a train. Since remaining time until the user transfers to a next train which is extracted from time table information is displayed in a lower part of a screen of the display part 14, so that the user can simply determine whether or not the user needs to hurry.

FIG. 6D is a display example when the user browses recent conditions of a friend as the simple content information in the SNS.

As described above, in the exemplary embodiment, the content processing server 3 basically provides the simple content information via the network 1 to the wrist terminal 7 through the smart phone 6. However, when the application programs for the services are already installed in the smart phone 6, the application programs themselves in the smart phone 6 may sometimes more preferably generate the simple content information to distribute and transmit the simple content information to the wrist terminal 7 without passing the content processing server 3.

As a representative example, a navigation application which carries out a navigation in real time may be exemplified.

FIGS. 7A and 7B show diagrams which illustrate examples of the simple content information generated in the smart phone 6 and displayed in the display part of the wrist terminal 7.

FIG. 7A illustrates a screen in which a delay arises due to an accident, so that a transferring guide to a route different from an ordinary route is provided by the application program of the transferring guide of the train.

FIG. 7B illustrates a screen when a route guide on the road to “turn to the right” is provided by the car navigation.

In these application programs which require a real time property, a position measurement for the navigation or a decision attended by an algorithm are more conveniently processed in the smart phone 6 side.

Accordingly, initially, the smart phone 6 directly obtains the content information from the content server 2 through the base station 5. Then, the smart phone 6 carries out a process such as a rasterizing process therein on the basis of the obtained content information to generate the simple content information. The smart phone 6 immediately distributes and transmits the generated simple content information to the wrist terminal 7. Thus, the display of the simple content information can be realized.

Further, in the above-described step C108, when the CPU 11 determines that the processes of all the simple content information are completed, the CPU 11 considers that the processes of the received simple content information are generally finished and returns to the processes from the above-described step C101 to prepare for the check timing of next simple content information.

As described above in detail, according to the present exemplary embodiment, a function of the smart phone is effectively and usefully used, and at the same time, maneuverability for the user can be improved and the distributed and transmitted content can be efficiently and assuredly treated.

Further, as shown in FIGS. 7A to 7B, the simple content information is generated in the smart phone 6 and distributed and transmitted to the wrist terminal 7 without daringly requiring a connection to the network 1. Thus, the simple content information which especially requires the real time property can be displayed by the wrist terminal 7.

Further, in the above-described exemplary embodiment, the simple content information is supposed to have a term of inspection and the simple content information whose term elapses is considered to be the simple content information whose term of validity expires and is not displayed. Thus, an unnecessary output of the simple content information can be automatically restricted, so that a complicated operation of the user can be omitted.

In addition thereto, in the exemplary embodiment, since the report forms of the simple content information can be set so as to meet the kinds of the content themselves, the maneuverability for the use can be more improved.

Further, in the above-described exemplary embodiment, when more detailed content information is necessary, the process called the redirect process that the wrist terminal 7 requests the smart phone 6 to automatically start the proper application program can be carried out. Thus, an operation necessary for the user of the smart phone 6 can be greatly simplified to improve more the maneuverability of the smart phone 6.

In the above-described exemplary embodiment, as explained above, the wrist terminal 7 is used for the smart phone 6. However, the present invention is not limited to the wrist terminal 7. Any terminals may be similarly applied thereto, which the user of the smart phone 6 wears, for instance, a terminal device of an over-glass type attached to an upper part of glasses or a head mount display and a wearable terminal attached to a part of clothes.

Additionally, the present invention is not limited to the above-described exemplary embodiment, and can be modified in various ways within a scope that does not deviate from a gist thereof in a stage of embodying. Further, functions carried out in the above-described exemplary embodiment can be suitably combined together and embodied as much as possible. In the above-described exemplary embodiment, various stages are included and various inventions may be extracted by suitably combining a plurality of disclosed components together. For instance, even when some components are deleted from all the components shown in the exemplary embodiment, if an effect can be obtained, a structure in which the components are deleted may be extracted as the invention.

1. A content distributing system comprising:
a first terminal device;
a second terminal device; and
a content processing server device,
wherein the content processing server device includes:
a selecting unit that selects whether or not content information for the first terminal device needs to be outputted to the second terminal device, the content information for the first terminal device being provided from an external part;
a content processing unit that generates simple content information optimized for the second terminal device based on the content information for the first terminal device which is selected as the necessary content information by the selecting unit; and
a distributing unit that distributes and transmits the simple content information generated by the content processing unit together with the original content information for the first terminal device to the first terminal device,
wherein the first terminal device includes:
a first receiving unit that receives the content information distributed and transmitted from the content processing server device;
a determining unit that determines whether or not the simple content information is added to the content information received by the first receiving unit; and
a transfer unit that transfers the simple content information to the second terminal device when the determining unit determines that the simple content information is added to the content information, and
wherein the second terminal device includes:
a second receiving unit that receives the simple content information transferred from the first terminal device; and
an output unit that outputs the simple content information received by the second receiving unit.

2. The content distributing system according claim 1,
wherein the first terminal device is a portable information terminal device and the second terminal device is a wearable terminal device.

3. The content distributing system according to claim 2,
wherein the portable information terminal device further includes:
a content generating unit that generates the simple content information optimized for the wearable terminal device by a preliminarily installed application program, and
wherein the transfer unit of the portable information terminal device transfers the simple content information generated by the content generating unit to the wearable terminal device.

4. The content distributing system according to claim 2,
wherein the simple content information includes term information which prescribes an output term, and
wherein the output unit of the wearable terminal device controls whether or not the simple content information is outputted by the output unit based on the term information included in the simple content information.

5. The content distributing system according to claim 2,
wherein the content processing unit of the content processing server device or the content generating unit of the portable information terminal device allows tag information to be included in the simple content information, the tag information designating a report form corresponding to a kind of the content information for the portable information terminal device, and
wherein the output unit of the wearable terminal device outputs the simple content information in the report form in accordance with the tag information included in the simple content information.

6. The content distributing system according to claim 2,
wherein the content processing unit of the content processing server device or the content generating unit of the portable information terminal device allows tag information to be included in the simple content information, the tag information instructing a reproduction of the content information for the portable information terminal device,
wherein the output unit of the wearable terminal device outputs to urge the instructed reproduction of the content information for the portable information terminal device based on the tag information included in the simple content information,
wherein the wearable terminal device further includes:
a reproduction request unit that receives the instruction of the reproduction of the content information for the portable information terminal device and that requests the portable information terminal device to reproduce the content information, and
wherein the portable information terminal device further includes:
an automatically reproducing unit that responds to the request by the reproduction request unit to start a corresponding application program and that reproduces the content information.

7. A server device which provides content to a portable information terminal device and a wearable terminal device which is connected to the portable information terminal device, the server device comprising:
a selecting unit that selects whether or not content information for the portable information terminal device needs to be outputted to the wearable terminal device, the content information for the portable information terminal device being provided from an external part;
a content processing unit that generates simple content information optimized for the wearable terminal device based on the content information for the portable information terminal device which is selected as the necessary content information by the selecting unit; and
a distributing unit that distributes and transmits the simple content information generated by the content processing unit together with the original content information for the portable information terminal device to the portable information terminal device.

8. A wearable terminal device which is connected to a portable information terminal device, the wearable terminal device comprising:
a receiving unit that receives simple content information which is transferred from the portable information terminal device, which includes tag information for designating a report form, which is generated based on content information for the portable information terminal device and which is optimized for the wearable terminal device; and
an output unit that outputs the simple content information received by the receiving unit in the report form in accordance with the tag information included in the simple content information.

9. The wearable terminal device according to claim 8,
wherein the receiving unit includes:
a report unit that carries out a forced report when the receiving unit receives the simple content information.

10. The wearable terminal device according to claim 9,
wherein the report unit carries out the forced report when information which instructs the forced report is included in the simple content information.

11. The wearable terminal device according to claim 8, further comprising:
a sensor that detects a movement of the wearable terminal device,
wherein when the sensor detects a prescribed movement, the output unit outputs the simple content information received by the receiving unit.

12. The wearable terminal device according to claim 11,
wherein the prescribed movement is a movement defined in the simple content information.

13. The wearable terminal device according to claim 8,
wherein when the receiving unit receives the simple content information, the output unit outputs the simple content information received by the receiving unit after a prescribed time.

14. The wearable terminal device according to claim 13,
wherein the prescribed time is a time defined in the simple content information.

15. A non-transitory computer readable medium storing a program that causes a server device to provide content to a portable information terminal device and a wearable terminal device which is connected to the portable information terminal device, the computer readable medium to provide content comprising:
selecting whether or not content information for the portable information terminal device needs to be outputted to the wearable terminal device, the content information for the portable information terminal device being provided from an external part;
generating simple content information optimized for the wearable terminal device based on the content information for the portable information terminal device which is selected as the necessary content information; and
distributing and transmitting the generated simple content information together with the original content information for the portable information terminal device to the portable information terminal device.

16. A non-transitory computer readable medium storing a program that causes a wearable terminal device which is connected to a portable information terminal device, the computer readable medium to provide content comprising:
receiving simple content information which is transferred from the portable information terminal device, which is generated based on content information for the portable information terminal device and which is optimized for the wearable terminal device; and
outputting the received simple content information.

17. A terminal device as a first terminal device in a content distributing system which includes the first terminal device, a second terminal device and a content processing server device, the terminal device comprising:
a first receiving unit that receives content information distributed and transmitted from the content processing server device;
a determining unit that determines whether or not simple content information is added to the content information received by the first receiving unit; and
a transfer unit that transfers the simple content information to the second terminal device when the determining unit determines that the simple content information is added to the content information.

18. A content distributing method of a server device which provides content to a portable information terminal device and a wearable terminal device which is connected to the portable information terminal device, the content distributing method comprising:
selecting whether or not content information for the portable information terminal device needs to be outputted to the wearable terminal device, the content information for the portable information terminal device being provided from an external part;
generating simple content information optimized for the wearable terminal device based on the content information for the portable information terminal device which is selected as the necessary content information; and
distributing and transmitting the generated simple content information together with the original content information for the portable information terminal device to the portable information terminal device.

19. A content distributing method of a portable information terminal device in a distributing system in which a server provides content to the portable information terminal device and a wearable terminal device which is connected to the portable information terminal device, the content distributing method comprising:
receiving content information distributed and transmitted from the content processing server device;
determining whether or not simple content information is added to the received content information; and
transferring the simple content information to the wearable terminal device when it is determined that the simple content information is added to the content information.
